(19) United States
(12) Patent Application Publication
(10) Pub. No.: US 2026/0157565 A1
(43) Pub. Date: Jun. 11, 2026

(54) POT STIRRER FOR INDUCTION COOKING VESSEL

(71) Applicant: LG ELECTRONICS INC., Seoul (KR)

(72) Inventors: Sungpil KIM, Seoul (KR); Byung Soo OH, Seoul (KR); Hanjin JUNG, Seoul (KR); Sungkyung KIM, Seoul (KR); Yeon A JO, Seoul (KR); Byunghoon PARK, Seoul (KR); Min Kyu OH, Seoul (KR)

(73) Assignee: LG ELECTRONICS INC., Seoul (KR)

(21) Appl. No.: 19/180,537

(22) Filed: Apr. 16, 2025

(30) Foreign Application Priority Data
Aug. 5, 2024 (KR) 10-2024-0104033

(51) Int. Cl. A47J 36/16; A47J 43/044; A47J 43/07; A47J 43/08; B01F 27/07; B01F 27/091; B01F 27/112; B01F 27/213; B01F 27/90; B01F 35/222; B01F 35/31; B01F 35/32; B01F 101/00

(52) U.S. Cl. CPC A47J 36/165; A47J 43/044; A47J 43/0711; A47J 43/082; B01F 27/073; B01F 27/091; B01F 27/112; B01F 27/213; B01F 27/90; B01F 35/222; B01F 35/31; B01F 35/32025; B01F 35/3204; B01F 2101/1805

(57) ABSTRACT

Provided is a pot stirrer for an induction heating cooking vessel. The pot stirrer includes a support body detachably erected on a bottom surface of an induction heating cooking vessel made of a magnetic material by using a magnet, a rotating body mounted on a circumference of the support body to be rotatable around a vertical axis of the support body, a driving unit configured to rotate the rotating body, and at least one stirring mechanism coupled to one side of an outer circumferential surface of the rotating body.

### CROSS-REFERENCE TO RELATED APPLICATION

Pursuant to 35 U.S.C. § 119(a), this application claims the benefit of the earlier filing date and the right of priority to Korean Patent Application No. 10-2024-0104033, filed on Aug. 5, 2024, the contents of which are incorporated by reference herein in their entirety.

### BACKGROUND

### 1. Field of the Invention

The disclosure relates to a pot stirrer that is simply attached to a cooking vessel made of a magnetic material, such as an induction cooking vessel used in an induction cooker, to stir food.

### 2. Description of the Related Art

In recent years, the spread of devices that heat cooking vessels using electricity has been increasing.

Cooking devices or cookers for heating cooking vessels using electricity may be broadly classified into cookers using resistance heating and cookers using induction heating.

Of those cookers, a cooker using the induction heating, for example, an induction heating cooker is a device that cooks by utilizing a principle that a cooking vessel is heated by an eddy current induced on a metallic cooking vessel using a magnetic field, which is generated around a coil when high-frequency power of a certain magnitude is applied to the coil.

In some embodiments, when cooking food using a cooker, such as an induction heating cooker, it is necessary to stir the food being cooked to suppress the food from burning or sticking in a cooking vessel and to ensure that the food is cooked evenly.

Therefore, a pot stirrer is disclosed to relieve the fatigue caused by a cook directly stirring food during cooking and to enhance cooking convenience.

The pot stirrer includes stirring blades immersed in the food inside a cooking vessel and a driving motor for rotating the stirring blades. The stirring blades stir the food while rotating in the food by driving force of the driving motor.

Patent Document 1 (Korean Patent Application No. 10-2018-0099096) discloses an example in which a driving motor for rotating stirring blades is installed on a lid of a cooking vessel.

The pot stirrer of Patent Document 1 has disadvantages in that the pot stirrer is used only in a cooking vessel of a specific size that matches a size of a corresponding lid and is impossible to operate when the lid is taken off, and a cook is unable to check a cooking status of the food during cooking.

Patent Document 2 (Korean Patent Application No. 10-2019-0059376) discloses an example in which a driving motor is supported on an upper center of a cooking vessel by a bar-shaped frame which is coupled to one side of an upper end of the vessel.

The pot stirrer of Patent Document 2 is more improved than the pot stirrer of Patent Document 1 in view of being usable for relatively different sizes of vessels by adjusting the height and length of the frame. However, the pot stirrer of Patent Document 2 still has inconveniences, such as the need to adjust the height and length of the frame according to the size of the vessel, the difficulty in checking the cooking status of the food because a field of view is blocked by the bar-shaped frame crossing the upper side of the vessel, interference by the frame when putting in ingredients during cooking, and the like.

Patent Document 3 (Chinese Utility Model Publication No. CN218899143U) discloses a configuration in which a driving motor is arranged inside an induction heating cooker on which a cooking vessel is placed, and stirring blades are rotatably connected to the driving motor through a connecting shaft that vertically penetrates a bottom surface of the cooking vessel and the induction heating cooker.

Patent Document 3 has advantages that a field of view is not blocked during cooking and no interference occurs when putting in ingredients, but has disadvantages that a vessel including the stirring blades and an induction heating cooker including the driving motor should be used as a specific set because the stirring blades and the driving motor should be installed on the vessel and the induction heating cooker, respectively. It is also necessary to protect the driving motor from heat transferred from the cooker through the connecting shaft.

In the related art pot stirrers including Patent Documents 1 to 3, the stirring blades have a constant length. In some embodiments, when the radius of the vessel is smaller than the length of the stirring blade, the use of the pot stirrer is impossible, and when the radius of the vessel is significantly larger than the length of the stirring blade, stirring is performed only in the center of the vessel, which deteriorates stirring efficiency.

Accordingly, the related art pot stirrers have the disadvantages that the pot stirrers are difficult to be used for various sizes of cooking vessels or should replace the stirring blades depending on the sizes of cooking vessels due to having stirring blades of various sizes.

### SUMMARY

The disclosure has been derived to solve the above problems, and an aspect of the disclosure is to provide a pot stirrer for an induction cooking vessel having a structure capable of being simply attached to or detached from the cooking vessel.

Another aspect of the disclosure is to provide a pot stirrer for an induction cooking vessel having a structure capable of minimizing the pot stirrer from obstructing food in the cooking vessel.

Another aspect of the disclosure is to provide a pot stirrer for an induction cooking vessel having a structure capable of being used in various sizes of cooking vessels.

To solve the above problems, the inventors of the disclosure have devised a pot stirrer having a structure that may be attachable to an induction heating cooking vessel using a magnet, taking into account the fact that the induction heating cooker is a magnetic body.

A pot stirrer for an induction heating cooking vessel according to an embodiment may include a support body detachably erected on a bottom surface of an induction heating cooking vessel made of a magnetic material by using a magnet, a rotating body mounted on a circumference of the support body to be rotatable around a vertical axis of the support body, a driving unit configured to rotate the rotating body, and at least one stirring mechanism coupled to one side of an outer circumferential surface of the rotating body.

Accordingly, the pot stirrer can be easily attached to and detached from the bottom surface of the cooking vessel made of the magnetic material by using the magnet arranged on the support body.

According to an embodiment, the driving unit may include a motor detachably coupled to an upper surface of the support body through a rotation shaft aligned with the vertical axis of the support body, and a housing accommodating the motor therein and coupled to the rotating body to rotate integrally with the rotating body around the vertical axis of the support body in case that the motor operates.

The rotation shaft of the motor may protrude below a lower surface of the housing, a coupling groove may be formed in the upper surface of the support body such that the rotation shaft of the motor is fitted, the coupling groove of the support body may have a non-circular cross-sectional shape, and an end portion of the rotation shaft of the motor fitted into the coupling groove or a fixing member press-fitted to the end portion may have a cross-sectional shape corresponding to the coupling groove of the support body.

With this configuration, during the operation of the motor, the rotation shaft of the motor and a rotor having the rotation shaft may be kept fixed together with the support body, and instead, a stator of the motor and a housing accommodating the motor may rotate around the rotation shaft, such that the rotating body mounted on the circumference of the support body rotates.

The housing of the driving unit and the rotating body may be coupled to be rotatable integrally with each other by at least one coupling element, which is arranged circumferentially on an edge of the lower surface of the housing and an edge of an upper surface of the rotating body.

The coupling element may include a magnet arranged on one of the lower surface of the housing and the upper surface of the rotating body, and a magnet or magnetic body arranged on another one of the lower surface of the housing and the upper surface of the rotating body.

Alternatively, the coupling element may include a pin extending in a direction parallel to the vertical axis of the support body from one of the lower surface of the housing and the upper surface of the rotating body, and an accommodating groove formed in another one of the lower surface of the housing and the upper surface of the rotating body to accommodate the pin.

This may allow easy coupling and separation of the housing and the rotating body using the magnet or the coupling element including the pin and the accommodating groove.

According to an embodiment, the stirring mechanism may include a blade extending in a direction orthogonal to the vertical axis of the support body, and a coupling member arranged to couple the blade to one side of the outer circumferential surface of the rotating body.

The blade may be movable in the direction orthogonal to the vertical axis of the support body.

This may allow the pot stirrer to be used in cooking vessels of various sizes by moving the blade to correspond to the size of the cooking vessel.

According to an embodiment, the coupling member may be formed on one side of a lower portion of the rotating body to be convex to a radial outside of the rotating body, and may include at least one coupling hole formed through the coupling member in the direction orthogonal to the vertical axis of the support body, and the blade may include a rod having a length longer than a length of the coupling hole of the coupling member and inserted into the coupling hole to be movable along the coupling hole, and a pair of stirring panels fixed to opposite end portions of the rod.

This may allow the length of the blade to be adjusted by moving the blade, specifically, the rod, along the coupling hole.

The coupling hole of the coupling member and the rod of the blade inserted into the coupling hole may be arranged as two coupling holes and two rods, respectively, in a direction parallel to the vertical axis of the support body, and the pair of stirring panels fixed to the opposite end portions of the rods may connect the opposite end portions of each of the at least two rods.

This may result in firmly supporting the stirring panel, which directly stirs food, by the at least two rods.

According to another embodiment, the coupling member may be a coupling rail extending in the direction orthogonal to the vertical axis of the support body on one side of a lower portion of the rotating body, and the blade may have a length longer than a length of the coupling rail and is coupled to the coupling rail to be movable along the coupling rail.

The coupling rail may include a first part protruding radially outward from an outer circumferential surface of the rotating body, and a second part formed on an outer side of the first part and having a vertical width larger than a vertical width of the first part, and the blade may include a blade body having a front surface, an edge portion extending rearward by a certain length from an edge of an outer side of the front surface, and an open rear surface, and a coupling panel fitted to the edge portion of the blade body to close the open rear surface of the blade body, the coupling panel including an insertion hole through which the second portion is inserted into an inner space of the blade body, and a movement hole having a vertical width larger than that of the first part of the coupling rail and smaller than that of the second part, and extending from one side of the insertion hole in a longitudinal direction of the stirring mechanism.

With the configuration, food can be stirred by the front surface of the blade along the entire length of the blade, and the blade can be detached from the coupling rail through the insertion hole for separate cleaning and storage.

The blade may further include a locking element configured to suppress the blade from moving relative to the coupling rail during operation of the pot stirrer.

This can suppress the change in length of the stirring mechanism due to friction with food during operation of the stirring mechanism.

The locking element may include an adjustment panel extending inside the blade body along a longitudinal direction of the blade body, a front surface of the second part of the coupling rail being slidably brought into contact with the adjustment panel, and including a plurality of through holes formed at specific intervals along the longitudinal direction of the blade body, and a plurality of locking pins inserted into the through holes of the adjustment panel to be elastically supported toward the front surface of the second part of the coupling rail, and one of the plurality of locking pins may be inserted into a locking groove formed in the front surface of the second part of the coupling rail, to suppress a movement of the blade relative to the coupling rail.

An end portion of the locking pin on a coupling rail side and the locking groove in which the end portion of the locking pin is inserted may be formed in a hemispherical shape.

This may facilitate the insertion and separation of the locking pin into and from the locking groove.

The front surface of the blade body may be formed parallel to a plane orthogonal to a direction of rotation, may be inclined, or may have a concave central portion.

When the front surface of the blade is formed parallel to a plane orthogonal to the direction of rotation, a powerful stirring action may be performed on food. In another example, when the front surface of the blade is inclined or concave, food stirred by the blade may move upward along the inclined or concave front surface, thus to be stirred smoothly with less force.

According to an embodiment, the magnet may be arranged on a lower surface of the support body, and the support body may further include an anti-slip pad covering the magnet. Preferably, the anti-slip pad may be made of silicone rubber.

This can suppress the support body attached to the bottom surface of the cooking vessel from rotating together with the rotation shaft of the motor.

The driving unit may further include a battery configured to supply power to the motor, a switch configured to turn the motor on and off, and a control board configured to control an operation of the motor.

With the configuration, electrical components, such as the motor, the battery, the switch, and the control board, may be accommodated in the driving unit that does not need to be cleaned, thereby suppressing damage to the electrical components due to cleaning.

According to an embodiment, the support body may have a height set to be higher than a highest liquid level of food in the cooking vessel.

With the configuration, the driving unit coupled to the upper side of the support body may not be immersed in food, thereby minimizing the possibility of failure of electrical components, including the motor included in the driving unit, due to contact with the food.

### BRIEF DESCRIPTION OF THE DRAWINGS

The above and other aspects, features and other advantages of the disclosure will be more clearly understood from the following detailed description taken in conjunction with the accompanying drawings, in which:

FIG. 1 is a perspective view of a pot stirrer according to an embodiment;

FIG. 2 is an exploded lateral view of main components of the pot stirrer of FIG. 1;

FIG. 3 is a cut lateral view of a portion to illustrate the inside of the pot stirrer of FIG. 1;

FIG. 4 is a perspective view of a main part illustrating a coupling structure of a driving part, a stirring mechanism, and a fixing part of the pot stirrer of FIG. 1;

FIG. 5 is an enlarged perspective view of a stirring mechanism of the pot stirrer of FIG. 1;

FIGS. 6A and 6B are perspective views of a state in which the stirring mechanism of the pot stirrer of FIG. 1 has been adjusted to different lengths;

FIGS. 7A and 7B are lateral views of a state in which the pot stirrer of FIG. 1 operates inside a cooking vessel;

FIG. 8 is a perspective view of a pot stirrer according to another embodiment;

FIG. 9 is an enlarged perspective view of a stirring mechanism of the pot stirrer of FIG. 8;

FIG. 10 is a perspective view of an assembled state of blades of FIG. 9;

FIGS. 11A and 11B are cross-sectional views of a state in which the blades of FIG. 9 are coupled to a rotating body, wherein FIG. 11A illustrates a state in which a stopping pin of the blade is locked in a stopping groove of a fixing member, and FIG. 11B illustrates a state in which the stopping pin of the blade is not locked in the stopping groove of the fixing member;

FIGS. 12 and 13 are perspective views each for explaining a coupling structure of a stirring blade and a coupling rail;

FIGS. 14A and 14B are perspective views of a method for adjusting the length of the stirring blade of the pot stirrer of FIG. 8; and

FIGS. 15A and 15B are plan views each illustrating a state in which the lengths of the stirring mechanisms of the pot stirrer of FIG. 8 is adjusted according to a size of a vessel.

### DETAILED DESCRIPTION OF THE EMBODIMENTS

Hereinafter, a description will be given in more detail of a pot stirrer 10 according to the disclosure, with reference to the accompanying drawings.

For the sake of a brief description with reference to the drawings, the same or equivalent components may be provided with the same or similar reference numbers, and a description thereof will not be repeated.

In addition, a structure that is applied to one embodiment will be equally applied to another embodiment as long as there is no structural and functional contradiction in the different embodiments.

A singular representation may include a plural representation unless it represents a definitely different meaning from the context.

In describing the disclosure, if a detailed explanation for a related known function or construction is considered to unnecessarily divert the gist of the disclosure, such explanation has been omitted but would be understood by those skilled in the art.

The accompanying drawings are used to help easily understand the technical idea of the disclosure and it should be understood that the idea of the disclosure is not limited by the accompanying drawings. The idea of the disclosure should be construed to extend to any alterations, equivalents and substitutes besides the accompanying drawings.

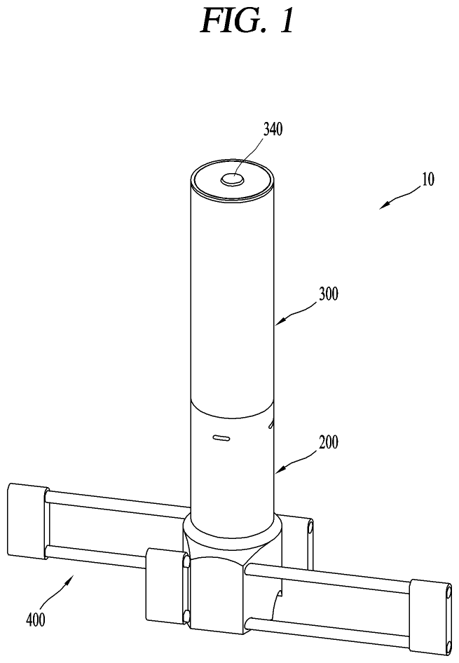

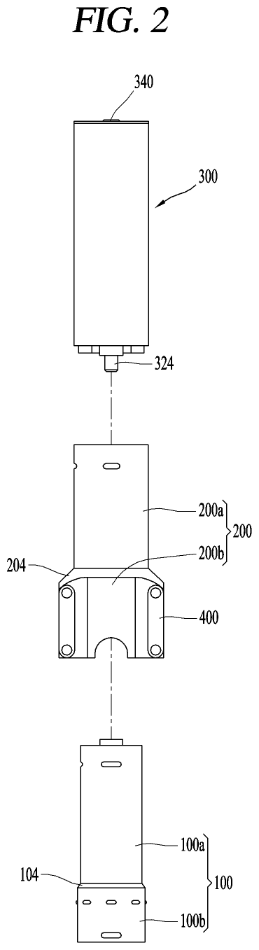

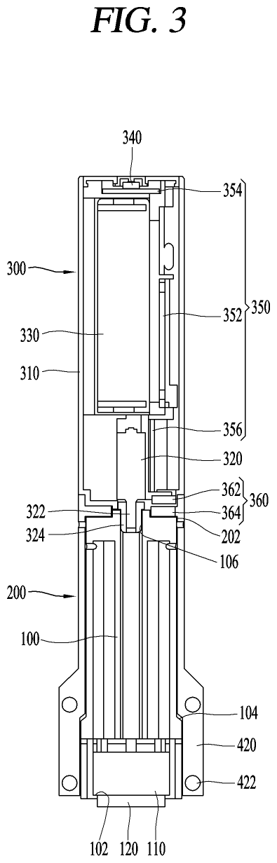

FIG. 1 is a perspective view of a pot stirrer 10 according to an embodiment. FIG. 2 is an exploded lateral view of main components of the pot stirrer 10 of FIG. 1. FIG. 3 is a cut lateral view of a portion to illustrate the inside of the pot stirrer 10 of FIG. 1.

As illustrated in FIGS. 1 to 3, a pot stirrer 10 according to an embodiment may include a support body 100, a rotating body 200, a driving unit 300, and a stirring mechanism 400.

For reference, in the description below, a Z direction may refer to a vertical axial direction of the support body 100 or an axial direction of a rotation shaft of a motor. A Y direction may be a direction orthogonal to the Z direction and may refer to a radial direction of a cooking vessel. An R direction may refer to a direction of rotation of the rotating body 200 that is rotated by the motor.

The support body 100 may be a cylindrical member that is detachably erectable on a bottom surface of an induction heating cooking vessel 20, that is, a cooking vessel 20 which is made of a magnetic material, for example, cast iron or ferritic stainless steel. In the following description, the term “cooking vessel” refers to an induction heating cooking vessel.

A magnet accommodating groove 102 which is circular may be formed in a lower portion of the support body 100 to be recessed into a lower surface of the support body 100 by a certain depth. A permanent magnet 110 may be accommodated in the magnet accommodating groove 102. A lower surface of the magnet accommodating groove 102 which is open may be closed by an anti-slip pad 120, and the anti-slip pad 120 may be made of a material with a high coefficient of friction, such as silicone rubber.

In the illustrated example, the support body 100 may be divided into an upper part 100a and a lower part 100b, and a diameter of the lower part 100b where the magnet accommodating groove 102 is formed may be slightly larger than a diameter of the upper part 100a. Accordingly, a jaw portion 104 may be arranged at a boundary between the lower part 100b and the upper part 100a of the support body 100. In this embodiment, the lower part 100b of the support body 100 may have a length of about ¼ to ⅓ of a length from the lower surface of the support body 100 to an upper end of the support body 100.

Preferably, the upper part 100a of the support body 100 may be formed hollow, i.e., with an empty inner space. This may help reduce the weight of the pot stirrer 10 according to the disclosure and reduce the amount of material needed for manufacturing the support body 100.

A rotation shaft coupling groove 106 may be formed in the center of an upper surface of the support body 100 to accommodate a rotation shaft 322 of a motor 320 of the driving unit 300 to be described later.

The support body 100 may be attached to a bottom surface 22 of a cooking vessel 20 by magnetic force of the permanent magnet 110 accommodated in the lower portion, and may also be detached from the bottom surface 22 of the cooking vessel 20 by a user forcibly pulling the support body 100.

Preferably, a height H1 of the support body 100 may be set higher than the highest liquid level HF of food F, which is being cooked in the cooking vessel 20. Accordingly, during cooking the food F, the driving unit 300 to be described later, which is coupled to an upper side of the support body 100, may be suppressed from being immersed in the food F, and moisture contained in the food F may not come into contact with electrical components including the motor 320 of the driving unit 300.

In some embodiments, an electromagnet may also be used as the magnet 110 accommodated in the support body 100. However, in case of using an electromagnet, the configuration of the support body 100 may become complicated and manufacturing costs may increase due to a structure for applying power to the electromagnet or a sealing structure for suppressing moisture from entering and causing malfunctions when the support body 100 is washed after being immersed in food. Therefore, using the permanent magnet 110 may be advantageous in terms of configuration and cost.

The rotating body 200 may be a hollow cylindrical member that covers a circumference of the support body 100. The support body 100 may be accommodated inside the rotating body 200 as the circumference of the support body 100 is covered with the rotating body 200. A diameter of the rotating body 200 may be slightly larger than a diameter of the support body 100.

After the rotating body 200 is mounted on the circumference of the support body 100, the rotating body 200 may rotate in the Y direction, for example, around a vertical axis of the support body 100.

The rotating body 200 may include an upper part 200a and a lower part 200b. As with the support body 100, a diameter of the lower part 200b of the rotating body 200 may be slightly larger than a diameter of the upper part 200a. Accordingly, a jaw portion 204 may be arranged at a boundary between the lower part 200b and the upper part 200a of the rotating body 200. In this embodiment, the lower part 200b of the rotating body 200 may have a length of about ¼ to ⅓ of a length from a lower end of the rotating body 200 to an upper end of the rotating body 200, similar to the lower part 100b of the support body 100.

An upper surface of the rotating body 200 may be formed in a ring shape with an open center.

In case that the rotating body 200 is fitted around the support body 100, the jaw portion 204 formed on an inner circumferential surface of the rotating body 200 may be seated on the jaw portion 104 formed on an outer circumferential surface of the support body 100, and accordingly, the rotating body 200 may rotate around the support body 100 while being stably mounted on the support body 100.

In an example not shown, the support body 100 may include the upper part 100a and the lower part 100b having the same diameter without the jaw portion 104, and the rotating body 200 may include the upper part 200a and the lower part 200b having the same diameter without the jaw portion 204. In this case, the rotating body 200 may be mounted on the support body 100 as the upper surface 202 of the rotating body 200 is placed on the upper surface of the support body 100.

The driving unit 300 may be placed on an upper side of the support body 100. The driving unit 300 may include a housing 310 formed in a hollow cylindrical shape, a motor 320, a battery 330 for supplying power to the motor 320, a switch 340 for turning the motor 320 on and off, and a control board 350 for controlling the operation of the motor 320. The motor 320, the battery 330, and the control board 350 may be accommodated inside the housing 310, and the switch 340 may be installed on an upper surface of the housing 310.

The housing 310 may have a diameter equal to the diameter of the rotating body 200 fitted around the support body 100 and may be a hollow cylindrical member with top and bottom closed.

The motor 320 may be accommodated in a lower portion of an inner space of the housing 310. As illustrated in FIGS. 2 and 3, a rotation shaft 322 of the motor 320 may protrude below a lower surface of the housing 310 through a through hole, which is formed through a center of the lower surface of the housing 310. The rotation shaft 322 of the motor 320 may be inserted into a coupling groove of the support body 100. This will be described again in detail later.

The battery 330 may be accommodated in an upper portion of the inner space of the housing 310, for example, above the motor 320, and may supply power for the operation of the motor 320 and the control board 350.

The switch 340 may be installed on the upper surface of the housing 310 and may be electrically connected to a switch board 354 which is positioned directly below an upper surface of the inner space of the housing 310. Preferably, the switch 340 may be mounted directly on the switch board 354 and may be exposed to the outside of the upper surface of the housing 310 through a through hole which is formed through the upper surface of the housing 310.

The control board 350 that controls the operation of the motor 320 may include a main control board 352, the switch board 354, and a motor driver 356, and may be arranged in the inner space of the housing 310.

The driving unit 300 having such a configuration may be coupled to the support body 100 through the rotation shaft 322 of the motor 320, and may be coupled to the rotating body 200 by at least one coupling element 360 interposed between the driving unit 300 and the rotating body 200. A coupling structure of the driving unit 300 with respect to the support body 100 and the rotating body 200 will be described as follows.

In case that the driving part 300 is placed on the upper side of the support body 100 and the rotating body 200, a fixing member 324 which is press-fitted to the rotation shaft 322 of the motor 320 protruding below the lower surface of the housing 310 may be fitted into the coupling groove 106 formed in the upper surface of the support body 100. The ring-shaped upper surface 202 of the rotating body 200 may be interposed between the driving unit 300 and the support body 100. In this case, the rotation shaft 322 of the motor 320 may be coupled to the coupling groove 106 of the support body 100 through an open central portion of the upper surface 202 of the rotating body 200. The driving unit 300 and the support body 100 may be coupled to each other by the rotation shaft 322 of the motor 320, which is fitted into the coupling groove 106 of the support body 100 through the fixing member 324.

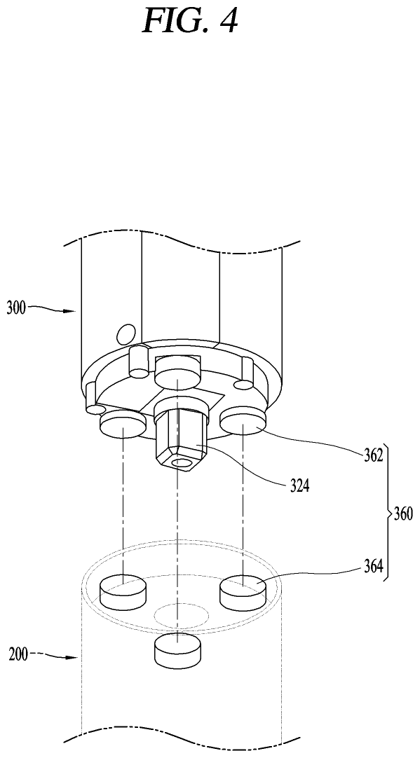

As illustrated in FIG. 4, the rotation shaft 322 of the motor 320 may have a circular cross-sectional shape, while the fixing member 324 press-fitted to an end portion of the rotation shaft 322 may have a square cross-sectional shape. The coupling groove 106 formed in the upper surface of the support body 100 in which the fixing member 324 is inserted may also have a square cross-sectional shape identical to the cross-sectional shape of the fixing member 324. Accordingly, in the state where the driving unit 300 is coupled to the support body 100 through the rotation shaft 322 of the motor 320, the rotation shaft 322 of the motor 320 and the support body 100 may not rotate relative to each other.

In the illustrated example, the fixing member 324 of the rotation shaft 322 and the coupling groove 106 of the support body 100 to which the fixing member 324 is coupled may have a square cross-sectional shape. However, the cross-sectional shape of the fixing member 324 and the coupling groove 106 is not necessarily limited thereto, and any cross-sectional shape may be applied as long as it may suppress the relative rotation between the rotation shaft 322 of the motor 320 and the support body 100. For example, the rotation shaft 322 of the motor 320 and the coupling groove 106 of the support body 100 may have a non-circular cross-sectional shape, such as an ellipse, rectangle, triangle, or cross.

Preferably, a cross-sectional area of the coupling groove 106 may be slightly larger than a cross-sectional area of the fixing member 324 to facilitate coupling and separation of the driving unit 300 and the support body 100.

Alternatively, the rotation shaft 322 of the motor 320 itself may have a non-circular cross-sectional shape, for example, a square cross-sectional shape. However, using the fixing member 324 with the square cross-sectional shape for the rotation shaft 322 with the circular cross-sectional shape may be advantageous in terms of facilitating the supply of components and reducing costs, compared to using the motor 320 having the rotation shaft 322 with a cross-sectional shape, which is not circular.

Alternatively, a fixing pin may be coupled through an end portion of the rotation shaft 322 of the motor 320 in a direction orthogonal to an axis of the rotation shaft 322 to protrude to one side or opposite sides of the rotation shaft 322, and a coupling groove may be formed in a shape that accommodates the rotation shaft 322 and the fixing pin.

In case that the driving unit 300 is placed on the upper side of the support body 100 and the rotating body 200, the driving unit 300 and the rotating body 200 may be coupled by at least one coupling element 360 interposed between the driving unit 300 and the rotating body 200. The coupling element 360 may include a pair of permanent magnets, for example, a first permanent magnet 362 and a second permanent magnet 364.

In the example illustrated in FIG. 4, total three coupling elements 360 may be arranged in a circle. That is, three first permanent magnets 362 may be arranged at certain intervals along a circumference of the rotation shaft 322 of the motor 320 on the lower surface of the housing 310 of the driving unit 300. Three second permanent magnets 364 may be arranged at certain intervals along a circumference of the open central portion of the upper surface 202 of the rotating body 200 on the upper surface 202 of the rotating body 200 that is in contact with the lower surface of the housing 310. Preferably, the second permanent magnets 364 may be press-fitted into accommodating holes formed in the upper surface 202 of the rotating body 200.

The first permanent magnet 362 and the second permanent magnet 364 may be located in corresponding positions and opposing surfaces may have different polarities. Accordingly, the housing 310 of the driving unit 300 and the rotating body 200 may be coupled by an attractive force between the first permanent magnet 362 and the second permanent magnet 264.

In the illustrated example, the three first permanent magnets 362 and the three second permanent magnets 364 may each be arranged at equal intervals of 120 degrees along the circumference. However, a different number of coupling elements 360, for example, two, four, five, or six coupling elements 360, i.e., a different number of pairs of first permanent magnets 362 and second permanent magnets 364, may be arranged.

Instead of the example in which each coupling element 360 including one pair of permanent magnets, one of the first permanent magnet 362 and the second permanent magnet 364 may be replaced with a magnetic substance, such as a steel plate or a nickel plate, which may be attached to a magnet.

In an alternative example not shown, each coupling element 360 may include a coupling protrusion protruding from the lower surface of the housing 310 of the driving unit 300, and a coupling groove formed in the upper surface 202 of the rotating body 200 to accommodate the coupling protrusion. In another example, a coupling protrusion may be formed on the upper surface 202 of the rotating body 200 and a coupling groove may be formed in the lower surface of the housing 310 of the driving unit 300. Preferably, three coupling elements each including a coupling protrusion and a coupling groove as a pair may be arranged at an interval of 120 degrees along the circumference.

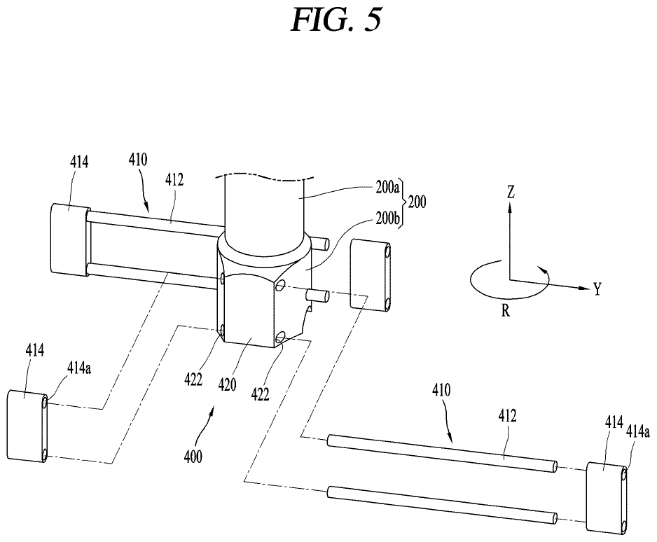

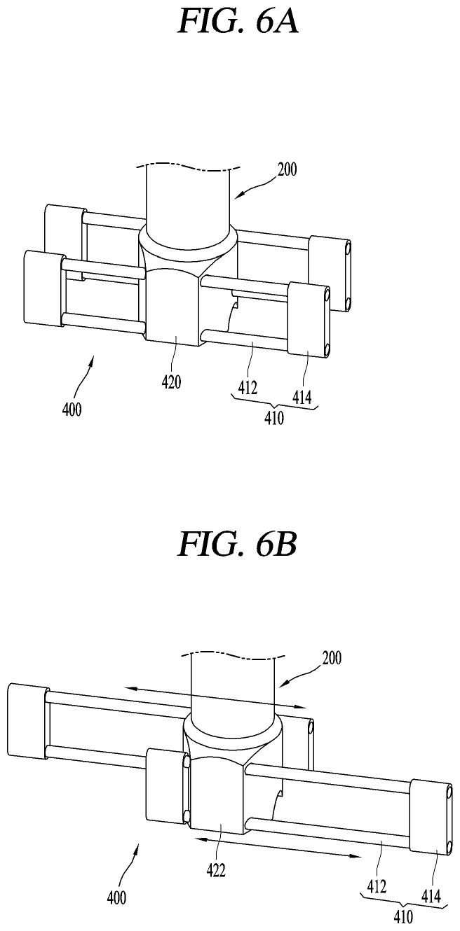

Hereinafter, the stirring mechanism 400 of the pot stirrer 10 according to an embodiment will be described with reference to FIGS. 5, 6A, and 6B. FIG. 5 is a partially exploded perspective view of the stirring mechanism 400 of the pot stirrer 10 illustrated in FIG. 1. FIG. 6A is a perspective view of a state in which the stirring mechanism 400 of FIG. 1 is adjusted to the minimum length. FIG. 6B is a perspective view of a state in which the stirring mechanism 400 is adjusted to the maximum length.

Referring to FIG. 5, a pair of stirring mechanisms 400 may be arranged on opposite sides in a radial direction of the rotating body 200 on an outer circumferential surface of the lower part 200b of the rotating body 200. The pair of stirring mechanisms 400 may each include a blade 410 and a coupling member 420. The blade 410 may be coupled to the rotating body 200 through the coupling member 420.

The coupling member 420 may be formed on the lower part 200b of the rotating body 200 to be convex to a radial outside of the rotating body 200. The coupling member 420 may be manufactured as a separate member from the rotating body 200 and thereafter fixed to the rotating body 200 or may be formed integrally with the rotating body 200.

The coupling member 420 may include a pair of coupling holes 422. The pair of coupling holes 422 may be arranged in an upper and lower direction of the coupling member 420, i.e., the Z direction, and may be formed to penetrate the coupling member 420 in a direction orthogonal to the Z direction, i.e., the Y direction. Although FIG. 5 illustrates an example in which the pair of coupling holes 422 are arranged, the number of coupling holes 422 may be one or at least three.

The blade 410 may include a pair of rods 412 and a pair of stirring panels 414.

The pair of rods 412 may be inserted into the pair of coupling holes 422 of the coupling member 420, respectively, to slide along the coupling holes 422. In the illustrated example, the coupling hole 422 and the rod 412 may have a circular cross-sectional shape. Alternatively, the coupling hole 422 and the rod 412 may have a non-circular cross-sectional shape, such as a square, a rectangle, or an oval.

The pair of stirring panels 414 may be approximately square panels arranged on opposite sides of the coupling member 420. Each of the stirring panels 414 may include holes 414a formed in upper and lower end portions along a width direction of the stirring panel 414. End portions of the pair of rods 412 on the same side may be inserted into the holes 414a of the stirring panel 414, to be connected in the upper and lower direction by the stirring panel 414, thereby blocking a space between the end portions of the rods 412.

The stirring mechanism 400 including the pair of blades 410 having the configuration may be adjusted in length by sliding the pair of blades 410 in the Y direction along the coupling holes 422 of the coupling member 420.

FIG. 6A illustrates an example in which central portions of the rods 312 of both of the pair of blades 410 are located in the center of the coupling holes 422 of the coupling member 420. In this state, the pair of stirring mechanisms 400 may have a minimum length in the radial direction (the Y direction) of the cooking vessel 20. The minimum length of the pair of stirring mechanisms 400 may limit a minimum diameter of the cooking vessel 20 to which the pot stirrer 10 according to the disclosure is applicable.

FIG. 6B illustrates an example in which the pair of blades 410 slide in opposite directions so that one stirring panel 414 of each of the blades 410 is adjusted to be adjacent to the coupling member 420. In this state, the pair of stirring mechanisms 400 may have a maximum length in the radial direction (the Y direction) of the cooking vessel 20. The maximum length of the pair of stirring mechanisms 400 may limit a maximum diameter of the cooking vessel 20 to which the pot stirrer 10 according to the disclosure is applicable to obtain a smooth stirring effect.

In this way, the pair of blades 410 may slide along the coupling holes 422 of the coupling member 420 in the radial direction (the Y direction) of the cooking vessel 20, thereby adjusting the length of the pair of stirring mechanisms 400 of the pot stirrer 10 according to the disclosure between the minimum length illustrated in FIG. 6A and the maximum length illustrated in FIG. 6B.

Hereinafter, a food stirring operation using the pot stirrer 10 according to an embodiment will be described.

A user may perform an assembling operation, in a sequence as illustrated in FIG. 2. For example, the user may fit the rotating body 200, to which the stirring mechanism 400 is coupled, onto the circumference of the support body 100 from the top of the support body 100, and couple the driving unit 300 to the support body 100 and the rotating body 200 from the top of the support body 100 and the rotating body 200, to obtain the assembled shape as illustrated in FIG. 1.

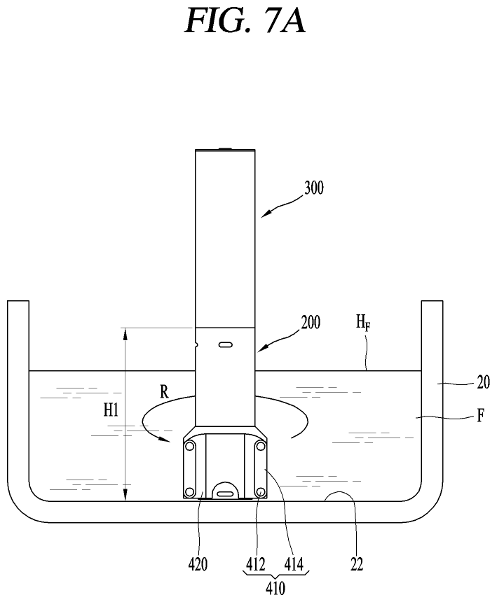

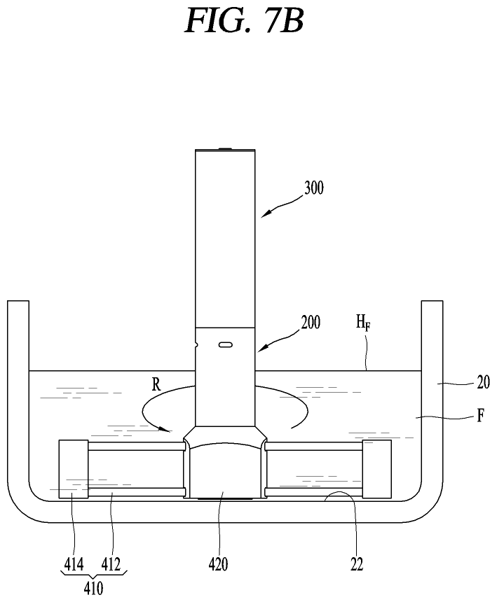

The user may then bring the lower surface of the support body 100 into contact with the center of a bottom surface 22 of the cooking vessel 20. Accordingly, the support body 100 may be attached to the bottom surface 22 of the cooking vessel 20 by the magnetic force of the permanent magnet 110 accommodated in the lower portion of the support body 100, and the pot stirrer 10 may be installed in an erected state on the bottom surface 22 of the cooking vessel 20 as illustrated in FIG. 7A.

Next, the length of the pair of stirring mechanisms 400 may be adjusted to correspond to the diameter of the cooking vessel 20 to be used by moving the pair of blades 410 in opposite directions.

After installing the pot stirrer 10 in the cooking vessel 20, the user may put food ingredients into the cooking vessel 20 and start cooking.

When the user presses the switch 340 installed on the upper surface of the driving unit 300 just before starting cooking or at an appropriate time point during cooking, the motor 320 may operate. However, as described above, the rotation shaft 322 of the motor 320 may be coupled to the coupling groove 106 of the support body 100 not to rotate relative to the support body 100. Therefore, when the motor 320 operates, the rotation shaft 322 of the motor 320 and a rotor having the same may remain fixed together with the support body 100, while a stator of the motor 320 and the housing 310 in which the motor 320 is accommodated may rotate around the rotation shaft 322.

For reference, the anti-slip pad 120 made of silicone rubber arranged on the lower surface of the support body 100 may suppress the permanent magnet 110 with a low coefficient of friction from rotating together with the support body 100 while being attached to the bottom surface 22 of the cooking vessel 20 during the operation of the motor 320.

In case that the housing 310 rotates by the operation of the motor 320, the rotating body 200 coupled to the housing 310 through the coupling element 360 may rotate accordingly, and the blades 410 of the pair of stirring mechanisms 400 coupled to the rotating body 200 may also rotate around the rotation shaft 322 of the motor 320, i.e., around the axis in the Z direction (FIGS. 7A and 7B). Then, food F may be stirred by the pair of stirring panels 414 arranged on opposite ends of each blade 410.

Rotation speed of the blades 414 of the stirring mechanism 400 may also be adjusted depending on cooking conditions, such as the viscosity or amount of the food F being cooked. For example, for curry in the range of approximately 5,000 cps to 10,000 cps, the rotation speed of the stirring mechanism 400 may be 5 turns per minute (5 rpm).

When cooking is completed, the pot stirrer 10 may be removed from the cooking vessel 20, and the driving unit 300 may be separated from the support body 100 and the rotating body 200 by forcibly pulling the driving unit 300 upward. Afterwards, the support body 100 and the rotating body 200 may be separated and washed. If necessary, the stirring panel 414 and the rods 412 may be separated from each other and washed separately.

As mentioned above, the height H1 of the support body 100 may be set higher than the highest liquid level HF of the food F in the cooking vessel 20, and electrical components, such as the motor 320 or the battery 330, may all be accommodated in the driving unit 300 coupled to the upper side of the support body 100. Therefore, the electrical components accommodated in the driving unit 300 may not be immersed in the food during cooking. The driving unit 300 may be separated from the support body 100 and the rotating body 200 after cooking is completed, the driving unit 300 does not need to be washed together with the support body 100 and the rotating body 200.

This may lower the possibility that moisture from food F penetrates the driving unit 300, thereby suppressing the failure of electrical components due to moisture. Thus, a waterproof structure to suppress moisture penetration may not need to be applied to the driving unit 300, resulting in simplifying the configuration of the pot stirrer 10 and reducing manufacturing costs.

Hereinafter, a pot stirrer 10 according to another embodiment will be described. A pot stirrer 10 according to another embodiment has the same configuration of the support body 100, the rotating body 200, and the driving unit 300 as the pot stirrer 10 according to the previously described embodiment, but has a difference in the configuration of a stirring mechanism 500. Accordingly, the configuration of the support body 100, the rotating body 200, and the driving unit 300 will not be described repeatedly, and the stirring mechanism 500 will be described in detail.

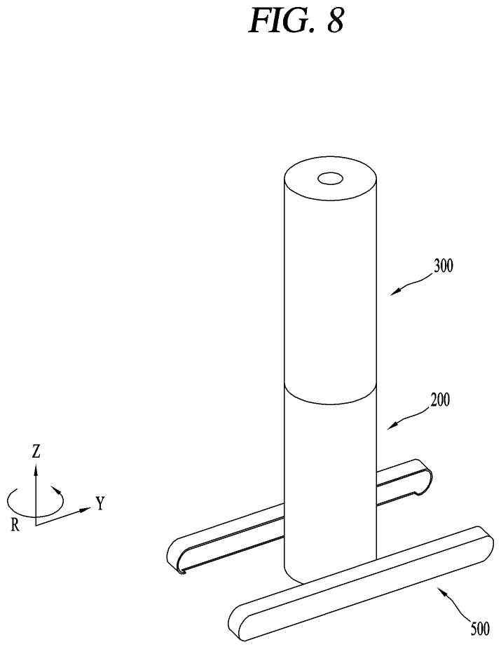

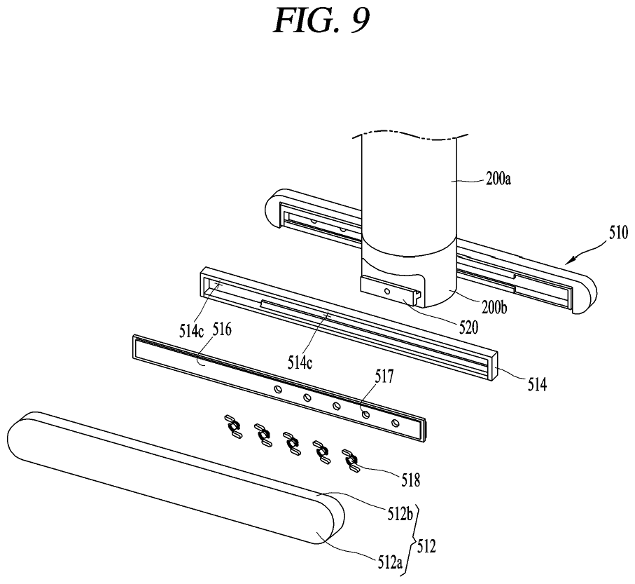

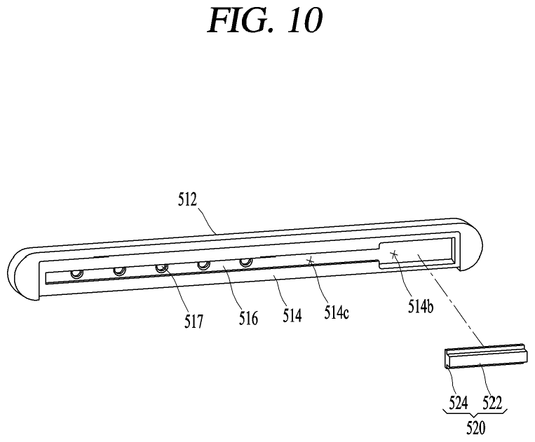

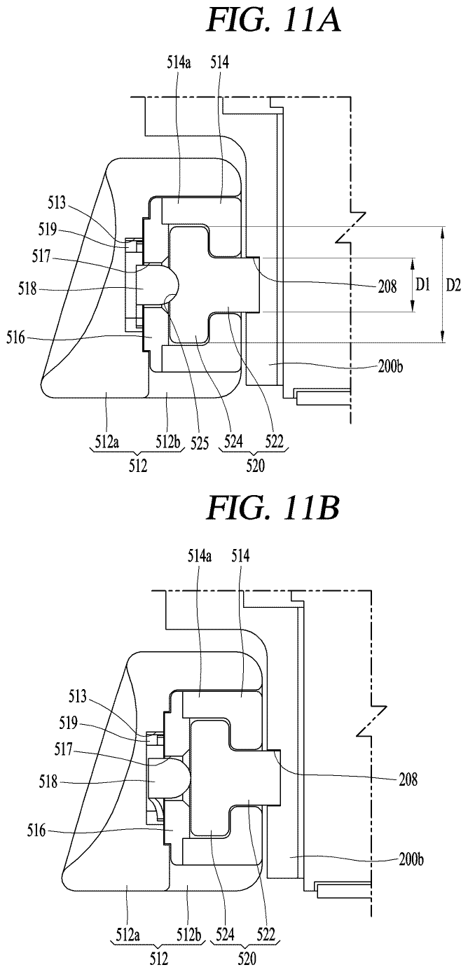

FIG. 8 is a perspective view of a pot stirrer 10 according to another embodiment. FIG. 9 is an exploded perspective view of a stirring mechanism 500 of the pot stirrer 10 illustrated in FIG. 8 in an enlarged state. FIG. 10 is a perspective view of an assembled state of a blade of FIG. 9. FIGS. 11A and 11B are cross-sectional views of a state in which the blade 510 of FIG. 9 is coupled to the rotating body 200.

Referring to FIGS. 8 and 9, the pot stirrer 10 according to another embodiment may include a pair of stirring mechanisms 500 arranged on opposite sides in the radial direction of the rotating body 200 on the outer circumferential surface of the lower part 200b of the rotating body 200. The pair of stirring mechanisms 500 may each include a blade 510 and a coupling member 520. The blade 510 may be coupled to the outer circumferential surface of the rotating body 200 through the coupling member 520.

As can be seen in FIG. 11A, the coupling member 520 according to this embodiment may be a rail-shaped member having a cross-section in a sideway T shape and extending in the Y direction. The coupling member 520 according to this embodiment may also be called a coupling rail.

The coupling rail 520 may include a first part 522 corresponding to a vertical part of the T shape and a second part 524 corresponding to a horizontal part of the T shape. A portion, to which the coupling rail 520 is fixed, on the outer circumferential surface of the lower part 200b of the rotating body 200 may be formed flat. A fixing groove 208, which extends in a direction parallel to the radial direction of the cooking vessel 20, i.e., in the Y direction, may be formed in the flat portion of the outer circumferential surface of the rotating body 200, and the coupling rail 520 may be fixed to the rotating body 200 to extend in a direction (the Y direction) parallel to the radial direction of the cooking vessel 20 by press-fitting an end portion of the first part 522 of the coupling rail 520 into the fixing groove 208.

In the illustrated example, a length of the coupling rail 520 may be slightly shorter than a diameter of the rotating body 200. Alternatively, the length of the coupling rail 520 may be equal to or longer than the diameter of the rotating body 200.

In case that the coupling rail 520 is fixed to the rotating body 200, a vertical width (an up-to-down width) D2 of the second part 524 of the coupling rail 520 may be larger than a vertical width D1 of the first part 522.

The blade 510 may include a blade body 512, a coupling panel 514, and a locking element. A length of the blade 510 in the Y direction may be longer than a length of a permanent magnet of the coupling rail 520, so that the length of the pair of stirring mechanisms 500 can be adjusted by moving the blade 510 along the coupling rail 520. For example, a ratio of the length of the blade 510 in the Y direction to the length of the coupling rail 520 in the Y direction may be approximately 5:1.

The blade body 512 may include a front surface 512a and an edge portion 512b extending rearward from an outer edge of the front surface 512a by a certain length, and a rear surface of the blade body 512 may be open. The coupling panel 514 may be fitted into the edge portion 512b of the blade body 512 to close the open rear surface of the blade body 512. Preferably, the coupling panel 514 may include an edge portion 514a that extends forward from an outer edge of the coupling panel 514 by a certain length. In case that the coupling panel 514 is coupled to the blade body 512, an outer surface of the edge portion 514a of the coupling panel 514 may be in close contact with an inner surface of the edge portion 512b of the blade body 512, and accordingly, the blade body 512 and the coupling panel 514 may be coupled more firmly.

The front surface 512a of the blade body 512 may be orthogonal to a rotational direction R of the rotating body 200. However, preferably, the front surface 512a of the blade body 152, as clearly illustrated in FIG. 11A, may be formed concavely while being inclined rearward from bottom to top of the front surface 512a with respect to the rotational direction R of the rotating body 200. Depending on the need, the front surface 512a of the blade body 512 may include only one of an inclined configuration and a concave configuration. According to this configuration, the food F stirred by the blade 510 may move upward along the inclined front surface 512a, thus to be stirred smoothly even with less force.

The coupling panel 514 may include an insertion hole 514b into which the coupling rail 520 may be inserted, and a movement hole 514c that allows the coupling rail 520 to move in a longitudinal direction of the coupling panel 514.

The insertion hole 514b may have a vertical width and a length that are slightly larger than the vertical width D2 and the length of the second part 524 of the coupling rail 520, and may be formed on one side of the longitudinal direction of the coupling panel 514. The movement hole 514c may extend from the insertion hole 514b to another side of the longitudinal direction of the coupling panel 514. The vertical width of the movement hole 514c may be equal to or slightly larger than the vertical width D1 of the first part 522 of the coupling rail 520.

A locking element may be arranged in an inner space of the blade body 512, that is, may be interposed between the front surface 512a of the blade body 512 and the coupling panel 514. The locking element may include an adjustment panel 516 and a plurality of locking pins 518.

The adjustment panel 516 may extend from one side to another side of the blade body 512 along the longitudinal direction of the blade body 512 in the inner space of the blade body 512. A plurality of through holes 517 may be formed through the adjustment panel 516 at certain intervals along the longitudinal direction of the adjustment panel 516. Referring to FIGS. 9 and 10, five through holes 517 may be formed from one side of the adjustment panel 516, for example, from an opposite side of the insertion hole 514b of the coupling panel 514. However, the number of through holes 516a is not necessarily limited to this.

The locking pins 518 may be fitted into the corresponding through hole 516a.

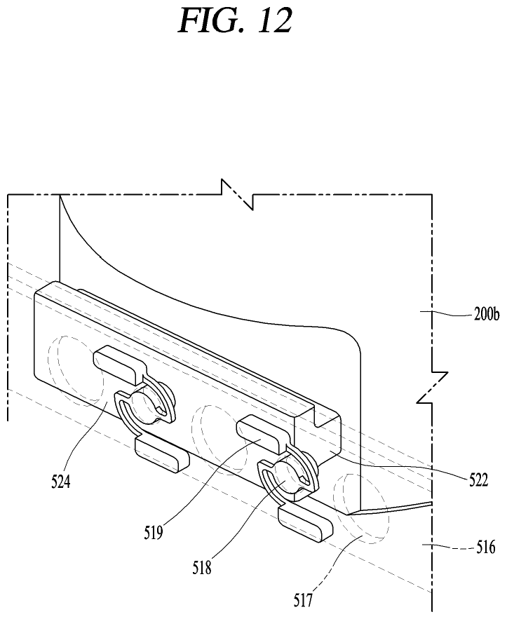

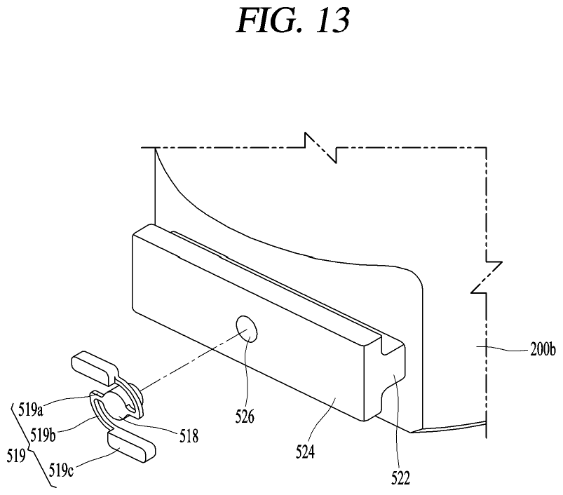

Referring to FIGS. 11A to 13, the locking pin 518 may have a shape of a circular pin with an end portion, which is located toward the coupling rail 520, formed in a hemispherical shape, and a pair of elastic pieces 519 may be attached to an end portion of the locking pin 518 opposite to the coupling rail 520. The pair of elastic pieces 519 may serve to elastically support the locking pin 518 toward the coupling rail 520.

Each elastic piece 519 may include a first part 519a extending radially outward from an end of the locking pin 518, a second part 519b extending in an arcuate shape from an end of the first part 519 along a circumferential direction of the locking pin 518, and a third part 519c having a substantially rectangular shape formed on an end of the second part 519b. The third part 519c may be formed thicker than the first part 519a and the second part 519b. The pair of elastic pieces 519 may be firmly supported by the third parts 519c on the edge portion 512b of the blade body 512. In the illustrated example, the pair of elastic pieces 519 may be accommodated in an accommodating groove 513 formed in an inner surface of the front surface 512a of the blade body 512.

In some embodiments, a locking groove 525 may be formed in a hemispherical concave shape in the center of a surface, which comes into contact with the adjustment panel 516, of the second part 524 of the coupling rail 520, and the hemispherical end portion of the locking pin 518 may be accommodated in the locking groove 525. The blade 510 may slide along the coupling rail 520 so that the hemispherical end portion of one of the plurality of locking pins 518 is inserted into the locking groove 525 of the coupling rail 520, thereby locking the blade 510 from sliding relative to the coupling rail 520. This will be described in more detail below.

Referring back to FIGS. 9 and 11A, the blade 510 may be assembled by inserting the adjustment panel 516 having the locking pins 518 fitted into the plurality of through holes 516a, respectively, into the inner space of the blade body 512, and then fitting the coupling panel 514 into the blade body 512 to close the rear surface of the blade body 512. A space which has a width corresponding to a thickness of the second part 524 of the coupling rail 520 may be defined between the adjustment panel 516 and the coupling panel 514 of the assembled blade 510.

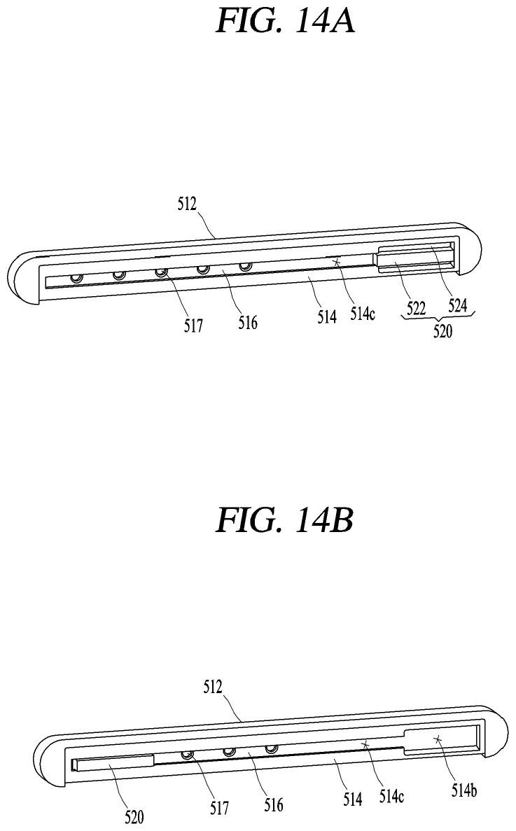

As illustrated in FIG. 14A, the second part 524 of the coupling rail 520 may be inserted into the space between the adjustment panel 516 and the coupling panel 514 through the insertion hole 514b of the adjusting panel 516.

Then, as illustrated in FIG. 14B, in case that the blade 510 slides in the longitudinal direction along the coupling rail 520 so that the second part 524 of the coupling rail 520 is released from the through hole 517 of the adjustment panel 516, the second part 524 of the coupling rail 520 may be supported by the adjustment panel 516 not to be separated from the blade 510, and thereby the blade 510 may be coupled to the rotating body 200 through the coupling rail 520. FIG. 14B illustrates a state in which the coupling rail 520 has completely moved to the opposite side of the insertion hole 514b of the coupling panel 514.

The pair of stirring mechanisms 500 according to another embodiment of FIGS. 9 to 13 having such a configuration may be adjusted in length by sliding the pair of blades 510 coupled to the rotating body 200 to opposite sides in the Y direction along the coupling rail 520.

Each of the plurality of locking pins 518 of the blade 510 may be elastically supported toward the coupling rail 520 by the pair of elastic pieces 519. In case that the coupling rail 520 moves toward the blocking pin 518 of the blade 510 and the hemispherical end portion of the blocking pin 518 is brought into contact with the second part 524 of the coupling rail 520, the locking pin 518 may be maintained in the state that the locking pin 518 has been moved toward the front surface 512a of the blade 510 by the second part 524 of the coupling rail 520. This state is illustrated in FIG. 11B.

While the blade 510 continuously slides along the coupling rail 520, in case that one of the plurality of locking pins 518 reaches a position of the locking groove 525 formed in the second part 524 of the coupling rail 520, the locking pin 518 may move toward the locking groove 525 by the elasticity of the pair of elastic pieces 519, and the hemispherical end portion of the locking pin 518 may be accommodated in the locking groove 525 of the second part 524 of the coupling rail 520 as illustrated in FIG. 11A.

In this state, the blade 510 may be locked with respect to the coupling rail 520 at a position adjusted by the user.

In case that the user applies force to slide the blade 510 relative to the coupling rail 520, the hemispherical end portion of the locking pin 518 may be released from the locking groove 525 and the hemispherical end portion of another adjacent locking pin 518 may be locked in the locking groove 525, thereby adjusting the length of the blade 510.

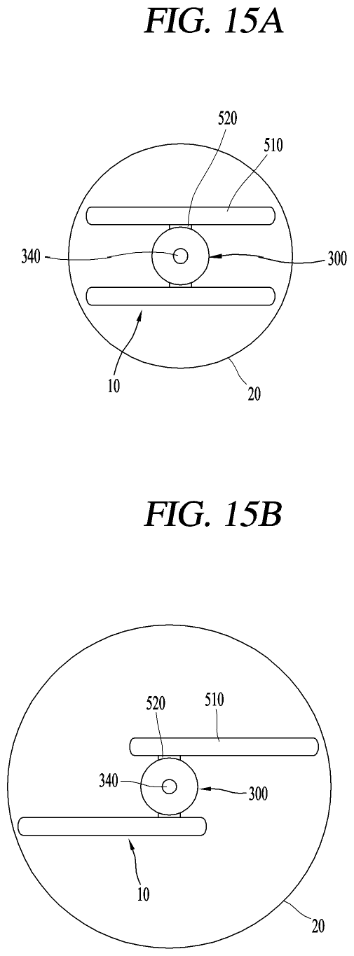

In this embodiment, the length of the pair of stirring mechanisms 500 may be adjusted between the minimum length illustrated in FIG. 15A and the maximum length illustrated in FIG. 15B.

For example, as illustrated in FIG. 15A, in case that both of the pair of blades 510 are adjusted so that the center portions of the blades 510 are located at the center portion of the coupling rail 520, the pair of stirring mechanisms 500 may have a minimum length in the radial direction of the cooking vessel 20. As described above, the minimum length of the pair of stirring mechanisms 500 may limit a minimum diameter of the cooking vessel 20 to which the pot stirrer 10 according to the disclosure is applicable.

FIG. 15B illustrates a state in which the pair of blades 510 have fully slid in opposite directions. In this state, the pair of stirring mechanisms 500 may have a maximum length in the radial direction of the cooking vessel 20. The maximum length of the pair of stirring mechanisms 500 may limit a maximum diameter of the cooking vessel 20 to which the pot stirrer 10 according to the disclosure is applicable to obtain a smooth stirring effect.

In some embodiments, in the embodiments illustrated in FIGS. 9 to 15B, the length of the blade 510 may be adjusted stepwise by inserting the hemispherical end portion of one of the plurality of locking pins 518 of the blade 510 into the hemispherical locking groove 525 of the coupling rail 520, and the blade 510 may be locked at the adjusted length.

In an alternative example in which the blade 510 does not include the adjustment panel 516 and the locking pin 518, the length of the blade 510 may be continuously adjusted by sliding the blade 510 along the coupling rail 520. In this case, the length of the blade 510 may be maintained in the adjusted state by frictional force between the second part 524 of the coupling rail 520 and the front surface 512a of the blade body 512 and the coupling panel 514.

In the stirring mechanism 500 according to this embodiment, the blade 510 may slide so that the coupling rail 520 is positioned in the insertion hole 514b of the blade 510, and may be easily separated from the coupling rail 520 through the insertion hole 514b after cooking is completed. Accordingly, the blade 510 can be easily separated and washed.

A pot stirrer according to the disclosure may be attached to a bottom surface of a cooking vessel using magnets arranged on a lower surface of a support body, thereby being installed on and removed from the cooking vessel in a simple and convenient manner.

A pot stirrer according to the disclosure may be attached to a bottom surface of a cooking vessel using magnets. This structure does not need to install a configuration for supporting the pot stirrer on a lid or upper end of the cooking vessel as in the related art, which may facilitate checking of a cooked state of food during cooking.

A pot stirrer according to the disclosure may adjust a length of a stirring mechanism using a blade according to a size of a cooking vessel, thereby being used for cooking vessels of various sizes.

A pot stirrer according to the disclosure may be configured such that a driving unit including electrical parts including a motor is arranged above a support body having a height higher than the highest liquid level of food, thereby suppressing the failure of the electric parts included in the driving unit due to the driving unit being in contact with food.

The aforementioned pot stirrer 10 is not limited to the configurations and methods of the embodiments described above, but the embodiments may be modified in various ways by selectively combining some or all of the embodiments.

The term “induction heating cooking vessel” described above should not necessarily refer only to cases where it is used in an induction heating cooker, but should be interpreted to refer to all cooking vessels made of a magnetic material to which a pot stirrer according to the disclosure is attachable.

It will be apparent to those skilled in the art that the disclosure may be embodied in other specific forms without departing from the spirit or essential characteristics thereof. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. A pot stirrer for an induction heating cooker, the pot stirrer comprising:
a support body detachably erected on a bottom surface of an induction heating cooking vessel made of a magnetic material by using a magnet;
a rotating body mounted on a circumference of the support body to be rotatable around a vertical axis of the support body;
a driving unit configured to rotate the rotating body; and
at least one stirring mechanism coupled to one side of an outer circumferential surface of the rotating body.

2. The pot stirrer of claim 1, wherein the driving unit comprises:
a motor detachably coupled to an upper surface of the support body through a rotation shaft aligned with the vertical axis of the support body; and
a housing accommodating the motor therein and coupled to the rotating body to rotate integrally with the rotating body around the vertical axis of the support body in case that the motor operates.

3. The pot stirrer of claim 2, wherein the rotation shaft of the motor protrudes below a lower surface of the housing,
a coupling groove is formed in the upper surface of the support body such that the rotation shaft of the motor is fitted, and
the coupling groove of the support body has a non-circular cross-sectional shape, and an end portion of the rotation shaft of the motor fitted into the coupling groove or a fixing member press-fitted to the end portion has a cross-sectional shape corresponding to the coupling groove of the support body.

4. The pot stirrer of claim 3, wherein the housing of the driving unit and the rotating body are coupled to be rotatable integrally with each other by at least one coupling element, which is arranged circumferentially on an edge of the lower surface of the housing and an edge of an upper surface of the rotating body.

5. The pot stirrer of claim 4, wherein the coupling element comprises:
a magnet arranged on one of the lower surface of the housing and the upper surface of the rotating body; and
a magnet or magnetic body arranged on another one of the lower surface of the housing and the upper surface of the rotating body.

6. The pot stirrer of claim 4, wherein the coupling element comprises:
a coupling protrusion protruding in a direction parallel to the vertical axis of the support body from any one of the lower surface of the housing or the upper surface of the rotating body; and
a coupling groove formed in another one of the lower surface of the housing and the upper surface of the rotating body to accommodate the coupling protrusion.

7. The pot stirrer of claim 1, wherein the stirring mechanism comprises:
a blade extending in a direction orthogonal to the vertical axis of the support body; and
a coupling member arranged to couple the blade to one side of the outer circumferential surface of the rotating body.

8. The pot stirrer of claim 7, wherein the blade is movable in the direction orthogonal to the vertical axis of the support body.

9. The pot stirrer of claim 7, wherein the coupling member is formed on one side of a lower portion of the rotating body to be convex to a radial outside of the rotating body, and comprises at least one coupling hole formed through the coupling member in the direction orthogonal to the vertical axis of the support body, and
the blade comprises a rod having a length longer than a length of the coupling hole of the coupling member and inserted into the coupling hole to be movable along the coupling hole, and a pair of stirring panels fixed to opposite end portions of the rod.

10. The pot stirrer of claim 9, wherein the coupling hole of the coupling member and the rod of the blade inserted into the coupling hole are arranged as two coupling holes and two rods, respectively, in a direction parallel to the vertical axis of the support body, and,
the pair of stirring panels fixed to the opposite end portions of the rod connect the opposite end portions of each of the at least two rods.

11. The pot stirrer of claim 7, wherein the coupling member is a coupling rail extending in the direction orthogonal to the vertical axis of the support body on one side of a lower portion of the rotating body, and
the blade has a length longer than a length of the coupling rail and is coupled to the coupling rail to be movable along the coupling rail.

12. The pot stirrer of claim 11, wherein the coupling rail comprises a first part protruding radially outward from an outer circumferential surface of the rotating body, and a second part formed on an outer side of the first part and having a vertical width larger than a vertical width of the first part, and
the blade comprises a blade body having a front surface, an edge portion extending rearward by a certain length from an edge of an outer side of the front surface, and an open rear surface, and a coupling panel fitted to the edge portion of the blade body to close the open rear surface of the blade body, the coupling panel comprising an insertion hole through which the second portion is inserted into an inner space of the blade body, and a movement hole having a vertical width larger than that of the first part of the coupling rail and smaller than that of the second part, and extending from one side of the insertion hole in a longitudinal direction of the stirring mechanism.

13. The pot stirrer of claim 12, wherein the blade further comprises a locking element configured to suppress the blade from moving relative to the coupling rail during operation of the pot stirrer.

14. The pot stirrer of claim 13, wherein the locking element comprises:
an adjustment panel extending inside the blade body along a longitudinal direction of the blade body, a front surface of the second part of the coupling rail being slidably brought into contact with the adjustment panel, and comprising a plurality of through holes formed at specific intervals along the longitudinal direction of the blade body; and
a plurality of locking pins inserted into the through holes of the adjustment panel to be elastically supported toward the front surface of the second part of the coupling rail, and
one of the plurality of locking pins is inserted into a locking groove formed in the front surface of the second part of the coupling rail, to suppress a movement of the blade relative to the coupling rail.

15. The pot stirrer of claim 14, wherein an end portion of the locking pin on a coupling rail side and the locking groove in which the end portion of the locking pin is inserted are formed in a hemispherical shape.

16. The pot stirrer of claim 12, wherein the front surface of the blade body is formed parallel to a plane orthogonal to a direction of rotation, is inclined, or has a concave central portion.

17. The pot stirrer of claim 1, wherein the magnet is arranged on a lower surface of the support body, and
the support body further comprises an anti-slip pad covering the magnet.

18. The pot stirrer of claim 17, wherein the anti-slip pad is made of silicone rubber.

19. The pot stirrer of claim 2, wherein the driving unit further comprises:
a battery configured to supply power to the motor;
a switch configured to turn the motor on and off; and
a control board configured to control an operation of the motor.

20. The pot stirrer of claim 2, wherein the support body has a height set to be higher than a highest liquid level of food in the cooking vessel.
